(19) United States
(12) Patent Application Publication
(10) Pub. No.: US 2015/0169392 A1
(43) Pub. Date: Jun. 18, 2015

(54) SYSTEM AND METHOD FOR PROVIDING AN APPLICATION PROGRAMMING INTERFACE INTERMEDIARY FOR HYPERTEXT TRANSFER PROTOCOL WEB SERVICES

(71) Applicants: Andrew E.S. MacKay, Carp (CA); Rafik Rezzik, Ottawa (CA); Kyle Fransham, Ottawa (CA)

(72) Inventors: Andrew E.S. MacKay, Carp (CA); Rafik Rezzik, Ottawa (CA); Kyle Fransham, Ottawa (CA)

(73) Assignee: Superna Incorporated, Ottawa (CA)

(21) Appl. No.: 14/548,674

(22) Filed: Nov. 20, 2014

Related U.S. Application Data
(60) Provisional application No. 61/906,724, filed on Nov. 20, 2013.

(51) Int. Cl. G06F 9/54; H04L 29/08

(52) U.S. Cl. CPC G06F 9/547; H04L 67/02; H04L 67/16

(57) ABSTRACT

The present invention provides a method for providing an application programming interface (API) intermediary for hypertext transfer protocol (http) web services having the following steps: receiving one or more API calls from one or more developer modules containing corresponding source IP addresses; analyzing the one or more API calls, the analysis having the step of copying all http data of the one or more API calls to a database, the http data containing respective destination IP addresses; and associating the one or more source IP addresses with the respective destination IP addresses for the one or more API calls.

### RELATED APPLICATION

This application claims the benefit of U.S. Provisional Patent Application No. 61/906,724, filed on Nov. 20, 2013, which is incorporated herein by reference.

### FIELD OF THE INVENTION

The present invention pertains to the field of software and in particular to an API diagnostic electronic platform.

### BACKGROUND

The traditional model for network management utilizes legacy protocols such as SNMP, TL1 or CLI commands. These protocols have device support across enterprise and telecom product segments. The SNMP protocol has been the predominant protocol for command and control of devices ranging from computers, network switches, routers, storage devices, optical and SONET/SDH transport devices.

SNMP v1, v2, and v3 have been preferred device management protocols. This has added an evolutionary efficiency on GET and RESPONSE messages, security and data privacy features between a control software function and the device.

The SNMP protocol was stateless, meaning no permanent session was required between management control station and the device. Autonomous notification was implemented using UDP messages to send to control stations to communicate an event, alarm, or change in condition on the device.

UDP has deficiencies including the non-guarantee delivery aspect of the protocol and messages could be lost by the network between the device and the management control station. This required special handling, often proprietary, to ensure messages were not lost.

The nature of SNMP was a textual MIB (Management Information Base) that required a compile function by the management station to make use of the standard or vendor specific features for GET or SET functions. This compile process was often error prone and required development effort to be able to issues commands from the management station to the device managed by the MIB file.

The MIB was often cryptic and built based on tables that only the developer of the MIB understood how to implement in software control stations.

Web services were based on internet HTTP and HTTPS plus XML to carry API calls between machines. Two protocols were standardized: SOAP and REST. Both exist for different solutions with SOAP benefitting from header extensions, and WSDL (Web services Definition language) class and API descriptions that allowed development tools to auto generate native code and libraries based on the WSDL file. This greatly simplified development and API usage between machines. Market accepted implementations include Amazon EC2 SDK and VMware vcenter API which are both are based on SOAP.

SOAP's usage lends itself to commercial software development projects with fully compiled API used within an IDE.

A very large use case of software to device communications was enterprise customers and IT staff needing to automate tasks on devices. SNMP was almost never used due to the compile requirement and complexity required, poor support for NAT or PNAT between software and the device. IT staff used scripting tools to automate IT tasks, this required textual interface and a non-compiled implementation to be used for simple runtime scripting. As scripting languages become more robust and mimicked programming features similar to compiled languages, it offered IT the ability to develop in-house complicated scripting solutions.

The problem with scripting and CLI interfaces is that commands changing between software releases would break dependent scripts. CLI interfaces also had no true way to pass options or additional parameters to a command easily and error handling required parsing output from the CLI which often broke any error conditions not handled by the script.

Device manufacture vendors embraced REST API usage for its URI based human readable syntax, common to browser URI's, parameter passing on the URI was commonplace for web based applications, stateful and session based. Operating System support was universal for HTTP and HTTPS (Encrypted), scripting languages and applications, full NAT or PNAT support, public and private IP addressing, scripting support, error handling and parsing options in common languages like cscript, perl, python.

As vendors implement commands based on REST, no standards exist on the command hierarchy that should be supported over REST, as REST has no support for defining type definitions (i.e., WSDL and SOAP). This means scripting or software management station to device adaption for GET and SET functions will require knowledge of the API hierarchy, type definitions, authentication mechanisms (not standardized in REST), autonomous alarm or event notification between devices. The autonomous alarm or event notification between devices mandate device to device, and management station/script engine to device communications, require tools to validate API, type definition, response handling, authentication, and autonomous event notification.

Therefore there is a need to address the gaps required for independent software vendor and independent hardware vendor to validate management station to device API interoperability and development of compiled or scripted software solutions.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for providing an application programming interface intermediary for hypertext transfer protocol web services. In accordance with an aspect of the present invention, there is provided a method for providing an application programming interface (API) intermediary for hypertext transfer protocol (http) web services having the following steps: receiving one or more API calls from one or more developer modules containing corresponding source IP addresses; analyzing the one or more API calls, the analysis having the step of copying all http data of the one or more API calls to a database, the http data containing respective destination IP addresses; and associating the one or more source IP addresses with the respective destination IP addresses for the one or more API calls.

In accordance with another aspect of the present invention, there is provided a system for providing an application programming interface (API) intermediary for hypertext transfer protocol (http) web services having: a server configured to receive one or more API calls from one or more developer modules containing corresponding source IP addresses; a processing engine configured to analyze the one or more API calls, the analysis having copying all http data of the one or more API calls, the http data containing respective destination IP addresses, and wherein the processing engine is also configured to associate the one or more source IP addresses with the respective destination IP addresses for the one or more API calls; a database configured to store the copies of the http data of the one or more API calls; and an interface to a communication means configured to allow communication between the server, the processing engine, the one or more developer modules, and the database.

### BRIEF DESCRIPTION OF THE FIGURES

FIG. 1 illustrates an example of the general platform architecture;

FIG. 2 illustrates an example of a method of the platform architecture;

FIG. 3 illustrates an example of the system modules of the platform architecture; and

FIG. 4 illustrates an example of a dashboard configuration output for API metrics.

### DETAILED DESCRIPTION OF THE INVENTION

### Definitions

The term “device” may be defined as any apparatus capable of network access. The device may be wired or wireless. In some embodiments, the device may include a personal computer, tablet, mobile device, mobile phone, television, music player, personal organizer, or any similar electronic network enabled device. In some embodiments, the device may be wearable technology including, but not limited to, jewelry, watches, glasses, hats, clothing, shoes, socks—essentially anything that is placed on or in a person which includes network enablement. In at least one embodiment, the device may include an interface for accepting credit card payment or debit payments at a business for example. In at least one embodiment, the device may function autonomously with pre-set configurations.

The term “developer module” may be defined as any user, corporation, virtual user, software vendor, hardware vendor, IT consultant, or other party with any means to ascertain workings of API functionality over http.

Unless defined otherwise, all technical and scientific terms used herein have the same meaning as commonly understood by one of ordinary skill in the art to which this invention belongs.

### Electronic Platform Overview

The present invention provides a system and method for providing an application programming interface intermediary for hypertext transfer protocol web services.

The platform is enabled electronically whereby input to the platform is performed electronically by a number of modules, including one or more developer modules on the network to provide the necessary information required to provide API information to the developer modules and one or more third parties.

The platform is configured to function transparently meaning it is not detectable by the developer module or the target API for the purpose of testing the API's normal operating environment. In this way the performance of the functions as a visible intermediary target of the API calls for the purpose of testing the API in a proxy mode.

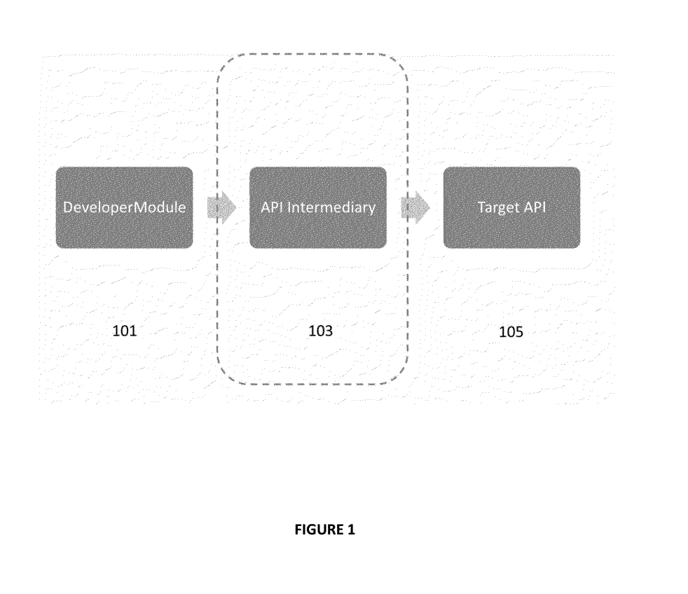

FIG. 1 illustrates an example of the system architecture whereby the platform (103) sits between the developer module (101) and the target API (105). In at least one embodiment, the developer module appears to be accessing the target API while in fact accessing the platform (e.g., API intermediary). In this fashion, the platform appears transparent.

In at least one embodiment, the electronic platform may be implemented by means of a software application. The above mentioned parties (e.g., developer modules, third party modules) interact with platform hardware/software modules and to fully execute the electronic platform.

The electronic platform may be implemented by any means known in the art including local installation of a software application on a mobile device with minimal retrieval of extraneous data from server. In at least one embodiment, the software application is a “thin client” on the user device and retrieves substantial amounts of information from server. In at least one embodiment, the software application is accessed through a network client (e.g., web browser, third party aggregator application). In at least one embodiment, the implementation of the application may include a hybrid of conventional paradigms such as those described above.

### Electronic Platform Modules

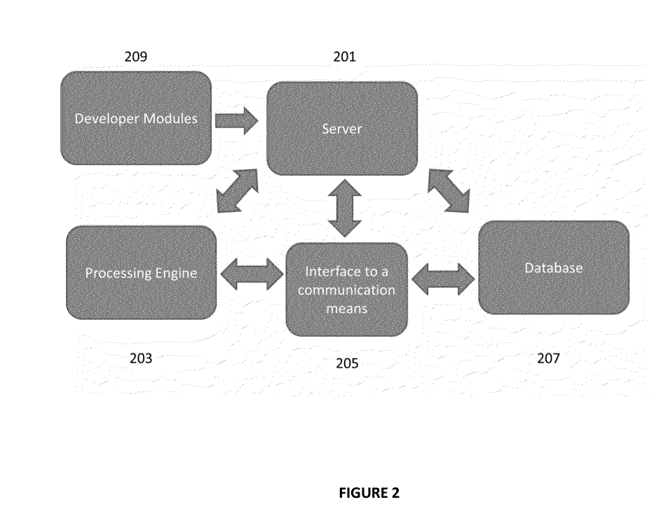

The platform requires a number of different platform modules which are configured to carry out discrete operations to accomplish the functions of the application programming interface intermediary for hypertext transfer protocol web services. FIG. 2 is an example of a typical platform configuration with a server (201), a processing engine (203), an interface to a communication means (205), a database (207), and develop modules (209).

A server is implemented which functions to receive input from the one or more users of the electronic platform. The server may be any hardware readily understood in the art which functions to receive the input information from the one or more developer modules on the electronic platform. The input information includes any type of information required for the determination of the instructions sent to an API and/or user device including, but not limited to, an API call, IP addresses, packet layer data, and the like. The server is configured to receive information (e.g., API calls) from multiple IP devices from one or more developer modules (e.g., one or more modules). In this way, the server routes and organizes the information (e.g., API calls) between the platform.

A database is implemented for the electronic platform which functions to store the information including, but not limited to, all http data from API calls. The database may be of any hardware known in the art which allows for the storage of the electronic platform. The hardware may be local hardware or network based hardware (e.g., “cloud-based”). In at least one embodiment, the database may be a discrete piece of hardware. In at least one embodiment, the database may be the same hardware as the server/processing engine performing discrete operations. The database interacts with any other hardware and or software modules of the system which provides requisition for data stored.

A processing engine is implemented for the electronic platform which computes various operations related to the information. The processing engine may be of any hardware known in the art which allows for the computation of data in an expedient fashion. The processing engine may be of any hardware understood by a person skilled in the art. The processing engine may be implemented by, but is not limited to, any processing unit capable of calculating rules based on a logic-set which may include both hardware and software components. The hardware may be local hardware or network based hardware (e.g., “cloud-based”). In at least one embodiment, the processing engine may be a discrete piece of hardware. In at least one embodiment, the processing engine may be the same hardware as the server/database performing discrete operations.

An interface to a communication means is implemented for the electronic platform such that any and all platform modules may communicate electronically with each other. For example, information stored in the database, processing engine, server, and developer modules may communicate with each other via a wide area network. Each component interfaces this communication means to accomplish communication. Communication means would be understood by a person skilled in the art to include any necessary elements of hardware, including but not limited to communications ports, wireless transmitter/receivers, wires or fiber optics; and software, including but not limited to telephony, e-mail, facsimile, Bluetooth®, TCP/IP, FTP, XML, and IRC, that allow a network enabled device to exchange data packets with another computing device.

### Electronic Platform Functions

The electronic platform, implemented over http, provides a variety of diagnostic and analytical data for APIs utilizing web services including, but not limited to, RESTful and SOAP implementations.

In at least one embodiment, the processing engine is configured to compute incoming API calls by intercepting the call from the developer module and analyzing the data packet. This may be executed in a variety of fashions including retrieving packet layer data from the http header or retrieving any relevant data layer from the data packet layer scheme.

In at least one embodiment, the processing engine analyzes an incoming information packet (e.g., API call) for an incoming IP address and a destination IP address. This may be done for multiple API calls. In this way, an association database may be created displaying the aggregate IP addresses incoming from a specific location and heading to a specific location. This analytical data is stored in a discrete part of the database and may be retrieved by developer modules and/or any third parties if the platform is configured to share the analytical information with the specified parties.

In at least one embodiment, the server records the timing of entry for the API call providing a time stamp for each incoming API call and subsequently stores this information in the database. The time stamps may be retrieved by any interested party (e.g., developer modules) depending on the platform's pre-set configuration. In at least one embodiment, the any or all of the server's functions may be conducted by the processing engine.

In at least one embodiment, the incoming API call data may be manipulated by the server whereby the http header and/or packet layer data may be manipulated to provide a desired change in behavior for the specific API call. The manipulations may be any manipulation to the data including, but not limited to, errors, fails, delays of delivery, and deletion of certain data from segments. For example, to insert a delay in an API call, the following steps would be followed: receive the API call and engage record the time elapsing from this point forward, allowing the API call to find its preprogrammed target, receiving a response from the remote API target, and analyzing the elapsed time from this process initiation. If the elapsed time is less than a user-specified delay, wait until enough time has elapsed to exceed the desired delay. Finally the response will be returned to the developer module with the inserted delay. In at least one embodiment, the any or all of the server's functions may be conducted by the processing engine.

In at least one embodiment, the incoming API call is manipulated by automating functions to circumvent the security within the API using a number of techniques. Techniques include, but are not limited to, replaying attempts of API sequences stored in the database, manipulating security authentication material, issuing non-secured API calls to overwhelm the target API, denying of service API replay of authentication requests aimed at disabling the authentication service for the purpose of by-passing authentication within the API, and producing an analysis report of the attempts and response of each simulated attack to provide the “Dashboard” a score of the API's security features and defenses to security attacks.

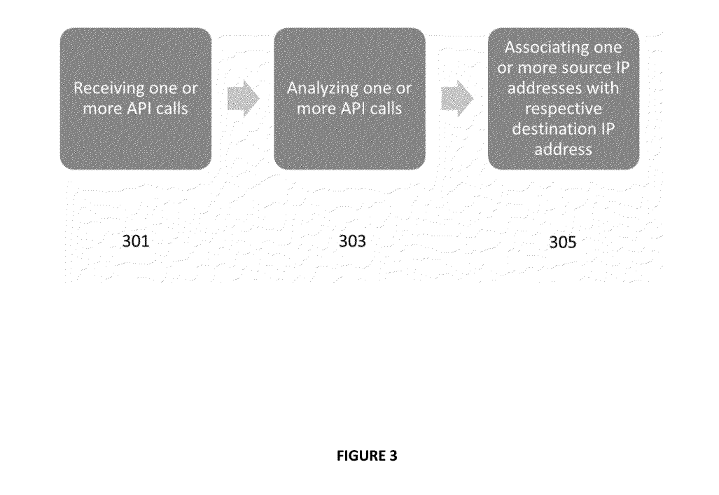

In at least one embodiment, the platform provides for a method for providing an application programming interface (API) intermediary for hypertext transfer protocol (http) web services which can be seen in FIG. 3.

The server is configured to receive one or more API calls from one or more developer modules containing corresponding source IP addresses (301). This involves the server to inspect the incoming data of the API call looking at the http header irrespective of the type of web services the incoming data is implementing (e.g., REST or SOAP). This analysis conducted by the server (303) comprises the step of copying all http data of the one or more API calls to a database. The http data contains a number of data elements including a destination IP address. Depending on the platform configuration, the server will copy various types of information and store this information in the database. The processing engine retrieves this information from the database (305) and associates the source IP address of the API call with the destination IP address of the API call. The processing engine may engage in further analysis of information stored in the database by the server depending on system configuration.

This above process may be repeated for one or more API calls which may or may not come from one or more developer modules.

### Information Analytics

Information related to the API calls received from the server is stored and sorted based on a pre-defined configuration. The information is stored in a database which receives the information from the server. The database sends the information to any and all parties requesting the information based on the configuration of the platform.

The information collected may include all http data from all API calls. The packet layer data for each API call may also be stored by the database. The platform may be configured to receive multiple API calls from multiple developer modules and target APIs.

In at least one embodiment, the collection of aggregated data is utilized for off-line analysis and trends within an API. For example, patterns or trends may be found through conventional statistical analysis methodologies showing a variety of metrics including, but not limited to, available routes for API calls, common/least common parameters, call times, http response codes, and versions. These analytics can be sorted by any pre-defined fashion. For example, the analytics may be sorted by individual developer modules, aggregate developer modules, subset of time interval, specific API calls, specific data metric within data packets, or any combination thereof.

Examples of the types of information determined by the statistical methodologies include security analysis with respect to API performance, marketing data with respect to API performance, efficiency data with respect to API performance, commonality of API usage data, data trends of accessed APIs, and indexing of data issued over APIs as source for searching for information. Analysis of methods of data retrieved of a live application for the purpose of identifying security methods used to prevent access to certain data within the target application are implemented in at least one embodiment.

In one example, API calls are analyzed for frequent “hot spots” which are areas of the API that are most popular and thus provide for an analysis of the profile of an application's most useful features based on analysis of the API routes and branches issued and the data received.

In at least one embodiment, cross application analysis (based on multiple APIs) may be implemented comparing two different sets of APIs for the purpose deriving commonality between them and producing a “report” that shows efficiencies about integrating APIs based on actual usage analysis.

This collected information may be accessed by any interested party. In at least one embodiment, the information may be requested by one or more developer modules. The developer module sends a request to the server for the collected information. In at least one embodiment, the server provides the information to the interested party (e.g., developer module) upon request. In at least one embodiment, the server provides the information to the interested party (e.g., developer module) if permissions set by the platform (e.g., server) allow for the transfer of information.

The collected data may be implemented electronically whereby a pre-defined threshold of values may be defined by a party such that the platform can process the relevant data and output the data accordingly. For example, if a threshold value of all API calls taking longer than 100 ms to process is desired, the platform will utilize this threshold value to calculate the relevant data and output the relevant data via the selected output method (e.g., dashboard).

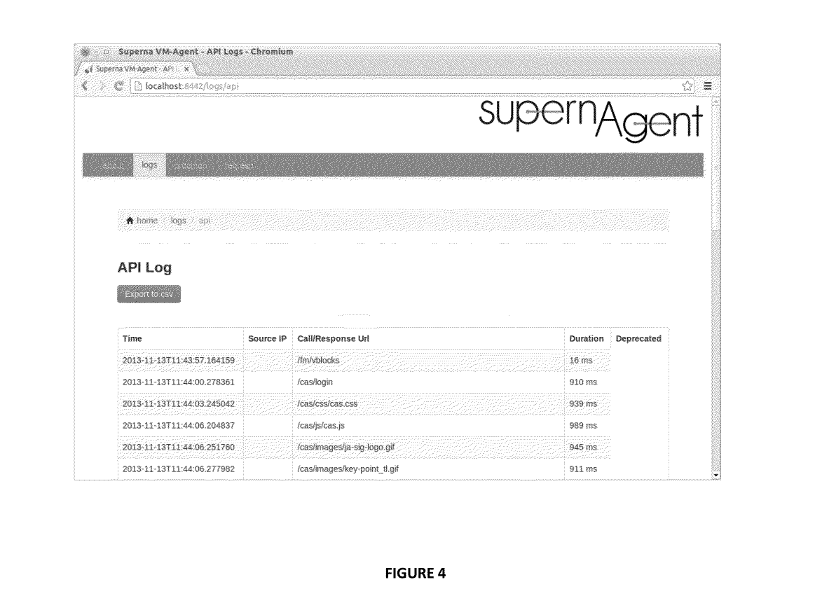

The collected information may be displayed in a variety of fashions. In at least one embodiment, a “dashboard” like interface is implemented which allows for various pre-defined metrics to be displayed graphically for each party (e.g., developer module). An example of a possible configuration for a dashboard output is illustrated in FIG. 4. The dashboard may also be utilized to configure and modify the parameters requests and responses of the API. In at least one embodiment, the dashboard is configured by the server. In at least one embodiment, the dashboard is configured by the developer modules.

In at least one embodiment, the output data may be in a text format including, but not limited to, spreadsheet data, text files, comma limited files, proprietary database files for ease of integration, and any other format readily understood by a worker skilled in the art used for exporting data.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for providing an application programming interface (API) intermediary for hypertext transfer protocol (http) web services comprising the following steps:
receiving one or more API calls from one or more developer modules containing corresponding source IP addresses;
analyzing the one or more API calls, the analysis comprising the step of copying all http data of the one or more API calls to a database, the http data containing respective destination IP addresses; and
associating the one or more source IP addresses with the respective destination IP addresses for the one or more API calls.

2. The method of claim 1 further comprising the steps of:
storing all associations of the one or more source IP addresses with the one or more destination IP addresses within the database; and
displaying all associations in a pre-determined format based on the associations.

3. The method of claim 1 further comprising the step of recording the time of the one or more API calls upon entry to the application programming interface intermediary.

4. The method of claim 3, wherein the times of the one or more API calls are displayed in a pre-determined format.

5. The method of claim 1 further comprising the step of inserting data impairments into the http data of the one or more API calls, the data impairments producing a desired outcome based on pre-selected functions.

6. The method of claim 1, further comprising the step of comparing http data of the one or more API calls to determine the entire response chain of the one or more API calls.

7. The method of claim 1, further comprising the step of analyzing http data of the one or more API calls stored within the database to determine aggregate pre-defined API call metrics.

8. The method of claim 7, wherein pre-defined API call metrics comprising at least one of: available routes for API calls, common/least common parameters, call times, and versions.

9. A system for providing an application programming interface (API) intermediary for hypertext transfer protocol (http) web services comprising:
a server configured to receive one or more API calls from one or more developer modules containing corresponding source IP addresses;
a processing engine configured to analyze the one or more API calls, the analysis comprising copying all http data of the one or more API calls, the http data containing respective destination IP addresses, and wherein the processing engine is also configured to associate the one or more source IP addresses with the respective destination IP addresses for the one or more API calls;
a database configured to store the copies of the http data of the one or more API calls; and
an interface to a communication means configured to allow communication between the server, the processing engine, the one or more developer modules, and the database.

10. The system of claim 9, wherein the database is further configured to store all associations of the one or more source IP addresses with the one or more destination IP addresses within the database and the processing engine is further configured to display all associations in a pre-determined format based on the associations.

11. The system of claim 9, wherein the processing engine is further configured to record the time of the one or more API calls upon entry to the application programming interface intermediary.

12. The system of claim 11, wherein the times of the one or more API calls are displayed in a pre-determined format.

13. The system of claim 9, wherein the processing engine is further configured to insert data impairments into the http data of the one or more API calls, the data impairments configured to produce a desired outcome based on pre-selected functions.

14. The system of claim 9, wherein the processing engine is further configured to compare http data of the one or more API calls to determine the entire response chain of the one or more API calls.

15. The system of claim 9, wherein the processing engine is further configured to analyze http data of the one or more API calls stored within the database to determine aggregate pre-defined API call metrics.

16. The system of claim 15, wherein pre-defined API call metrics comprises at least one of: available routes for API calls, common/least common parameters, call times, and versions.
